(19) United States
(12) Patent Application Publication
(10) Pub. No.: US 2024/0006097 A1
(43) Pub. Date: Jan. 4, 2024

(54) MODULE AND SYSTEM FOR ASSEMBLING ELECTRICAL CABLES

(71) Applicant: Komax SLE GmbH & Co., KG, Grafenau (DE)

(72) Inventors: Korbinian BREDL, Frauenau (DE); Matthias HELL, Frauenau (DE); Marcus HOPF, Thurmansbang (DE); Enny MORA-SANCHEZ, Vilshofen (DE); Marco WEININGER, Schönberg (DE)

(21) Appl. No.: 18/337,193

(22) Filed: Jun. 19, 2023

(30) Foreign Application Priority Data
Jun. 20, 2022 (EP) 22179942.2

(51) Int. Cl. H01B 13/00

(52) U.S. Cl. CPC H01B 13/0003

(57) ABSTRACT

A module (2) for a system (1) for assembling electric cables (19) includes a machine base (5) on which at least one processing station (22) for processing electric cables is mountable, and an asynchronous and pitch-free transport device (7) configured to transport at least one of the electric cables to and/or away from the at least one processing station.

### CROSS-REFERENCE

The present application claims priority to European patent application serial number 22 179 942.2 filed on 20 Jun. 2022, the contents of which are incorporated fully herein by reference.

### TECHNICAL FIELD

The present invention generally relates to a module for a system for assembling electrical cables and/or to a system for assembling electrical cables.

### BACKGROUND ART

Electrical cables are assembled, for example, to manufacture cable plug connections, i.e. to attach various plugs, connectors, etc. to ends of an electric cable. This is effected, for example, by crimping contact part(s) onto the cable end(s). Several work steps are usually required. For example, the cable ends are stripped, shields that might be present in the cable are expanded, and the contact parts are put onto the thus-prepared cable ends before the contact parts and the cable ends are fixedly connected to each other by crimping.

Systems for assembling electrical cables that carry out one or more such work steps in an automated or semi-automated manner are known. For example, WO 2020/020422 A1 discloses a system for automated assembly of cables.

Such systems usually have a fixed structure in which individual processing stations for carrying out work steps are provided next to each other in a specific sequence. The electrical cables to be assembled are moved by a transport device from one processing station to the next processing station, where the respective work steps are carried out. The transport device usually has one or more workpiece carriers for holding the electrical cables and, for example, a belt, a chain or a shaft for moving the workpiece carrier(s). In embodiments having multiple workpiece carriers, the movement of the workpiece carriers is usually effected in synchronous manner and with a fixed pitch, i.e. a fixed displacement distance per cycle time, due to the common drive. For example, when using a belt, all workpiece carriers attached to the belt are moved simultaneously and by the same distance in accordance with the movement of the belt.

The work steps at the individual processing stations can utilize (require) different-length processing times. However, due to the synchronous movement of the workpiece carriers, the workpiece carriers can be moved to the next processing station only when (after) the work step performed at every processing station has been completed. The minimum cycle time is thus determined by the processing station having the longest processing time. The production capacities are limited by this minimum cycle time.

In systems that have processing stations with different-length processing times, processing stations having short processing times may therefore be unused for a portion of the time, so that their capacities are not fully utilized. Furthermore, the spacing of the processing stations is rigidly fixed by the pitch.

### SUMMARY OF THE INVENTION

It is one non-limiting object of the present teachings to disclose techniques for improving the design of a system for assembling electrical cables and/or to increase the utilization efficiency of existing processing capacities.

In one non-limiting aspect of the present teachings, a module for a system for assembling electrical cables may include: a machine base on which at least one processing station for processing electrical wires is mountable; and an asynchronous and pitch-free transport device configured to transport at least one of the electrical cables to the at least one processing station and/or away from the at least one processing station.

In this aspect, a flexible design and arrangement of processing stations is made possible owing to the asynchronous and pitch-free transport device, which is provided (at least partially disposed) in the module. In particular, the transport device is not bound to a specific cycle or a specific movement distance. The capacities of processing stations can thus be utilized to a higher degree (more efficiently). If a processing station requires longer than a desired cycle time for processing, the processing station can be provided in a plural manner (i.e. multiple processing stations that perform the same processing can be provided) so that the particular processing step can be performed at multiple processing stations at least partially simultaneously and thus the cycle time can be shortened. If, for example, the processing time of a first processing station is approximately twice as long as the processing time of a second processing station, the first processing station can be provided in duplicate so that two electrical cables/cable ends can be processed in parallel at the two first processing stations and then transported to the second processing station one after the other to be processed at the second processing station. The two first processing stations can then process two new cables/cable ends again. The distance between one of the two first processing stations and the second processing station can be different from the distance between the other one of the two first processing stations and the second processing station. If there are even greater differences between the processing times of the first and second processing stations, more than two first processing stations can also be used. Fast processing stations having short processing times can be used in a plural manner. Because there is no fixed pitch, adjacent processing stations can be arranged (disposed) in a flexible manner. The utilization of the available space can be improved thereby.

In another aspect of the present teachings, by using a machine base having a welded frame, the stability and strength of the module can be increased. The welded frame can have, e.g., approximately the shape of a cube or a cuboid. The welded frame can have, for example, a substantially rectangular or square shape in a plan view along a z-axis. The welded frame can support the module on the floor and can be provided, e.g., with feet that rest on the ground. The welded frame can be formed, e.g., of profiles (e.g., one or more of bars, beams, struts, brackets, etc.) that are welded together. The welded frame can be made, e.g., of steel. The welded frame can preferably have a height along a z-axis in the range of 0.5 m to 1.5 m. The welded frame can preferably have a length along an x-axis in the range of 0.5 m to 10 m, preferably 1 m to 5 m, for example 1.5 m or 3 m. The welded frame can preferably have a width along a y-axis in the range of 0.5 m to 10 m, preferably 1 m to 5 m.

In another aspect of the present teachings, by attaching the transport device to a support of the machine base on which the processing stations are also mounted, tolerance stacking (tolerance chains) can be avoided, and thus overall manufacturing tolerances can be reduced. The support can be, e.g., a metal plate attached to the welded frame. A height and/or horizontal orientation of the support can be adjustable by compensating elements provided, for example, between the support and the welded frame. At least three or at least four or at least six compensating elements can be provided per module. The compensating elements can be height-adjustable, e.g., by means of a screw thread. The support can have, e.g., a plate. The plate can be oriented horizontally. Profiles (e.g., one or more of bars, beams, struts, brackets, etc.) for mounting processing stations can be provided on the plate. The support can have an integrated air reservoir. The welded frame can be arranged (disposed) between the support and the floor and can connect the support to the floor.

In another aspect of the present teachings, by using multiple independently-driven workpiece carriers, multiple electrical cables/cable ends can be processed in parallel at different processing stations and can be moved, e.g., to the next processing station after completion of the processing operation at one processing station in large part (at least substantially) independently of the processing status of the respective other cables/cable ends.

In another aspect of the present teachings, a workpiece carrier can be a device that holds (grasps) one or more electrical cables and/or one or more cable ends. The (each) workpiece carrier can be provided with one or more grippers (e.g., clamps) configured to hold the electrical cable(s) and/or cable end(s). The gripper(s) can be movable and configured to hold the cable(s) and/or cable end(s) by clamping. Movement of the gripper(s) to grip (clamp) or release the electrical cable(s) or cable end(s) can be effected, e.g., in one or more of a mechanical manner, an electrical manner, a magnetic manner, a pneumatic manner and/or a hydraulic manner. The movement can, e.g., be controlled individually for each gripper/workpiece carrier, e.g., by a central controller.

The workpiece carrier can be movable along a rail, e.g., by engaging with the rail. The workpiece carrier can, e.g., slide/float on/in the rail and/or can be provided with rollers for movement along the rail. The gripper(s) can be provided, e.g., at one end (e.g., an upper end) of the workpiece carrier, e.g., at a first end that is opposite of a second end that is coupled to the rail.

A magnetic drive of the workpiece carriers is an exemplary practical drive design, using which the workpiece carriers can be moved asynchronously and pitch-free, in particular independently of each other. A transport system having a magnetic drive can be easily extended and permits (enables) a large overall length of the system. The magnetic drive can be configured, e.g., such that the workpiece carriers are moved linearly along one or more rails using a magnetic field or magnetic fields. The transport device can include a linear motor having magnetically driven workpiece carriers. In particular, the workpiece carriers can be moved quasi continuously, i.e. with any resolution (e.g., with any arbitrary distance between adjacent workpiece carriers, in order words, pitch-free). The transport device can be, for example, a device such as the linear transport system XTS® of Beckhoff Automation GmbH.

The workpiece carriers can be moved, e.g., by an electric/mechanical drive. For example, a workpiece carrier can include an electric motor configured to drive a gear, which meshes with teeth on a rail, so that the workpiece carrier is moved along the rail. The workpiece carrier can include, e.g., a linear motor.

The workpiece carriers can be moved linearly (e.g., along a straight path), preferably along a horizontal direction. Such a transport system is easily extendable. The linear and pitch-free transport in conjunction with the processing stations makes possible a maximum (optimal) degree of filling (utilization) of the system over a minimum length, thereby improving system efficiency.

In an embodiment having two rails, the processing stations can be disposed along a first rail. The electrical cables/cable ends can be transported along this first rail from a starting point to an end point of a processing segment within the first rail. The workpiece carriers can be moved using the second rail back to the starting point of the first rail after, e.g., the particular processed cable has been deposited. Connecting pieces (diverters/reversing (curved) rails) at the ends of the two rails can connect the rails (e.g., straight rails) with each other so that the workpiece carriers at the end of one (e.g., straight) rail can be moved to the other (e.g., straight) rail, and vice versa.

The workpiece carriers can be moved, e.g., in a revolving (circulating) manner or can be moved back and forth in a reciprocating manner. For example, a workpiece carrier can pick up an electrical cable at a loading station, transport it from processing station to processing station and then deposit it in a deposit station after the processing has been completed. The workpiece carrier can then move back to the loading station along a closed or endless path.

Alternatively, certain workpiece carriers can be responsible for certain portions of the system. For example, one workpiece carrier can transport the electrical cables from the loading station to the first processing station. Another workpiece carrier or multiple workpiece carriers can pick up the electrical cables from the first processing station and move them from processing station to processing station. Still another workpiece carrier can transport the processed electrical cables from the last processing station to the deposit station. For reciprocating workpiece carriers, a single rail may be sufficient.

More than two rails can be provided. In particular, two rails parallel to each other can be provided next to each other at the same height, on which, for example, different workpiece carriers can move independently of each other. By using multiple rails, workpiece carriers can overtake or avoid each other. The rails can be connected to each other via adjustable track switches.

An embodiment in which the second rail is disposed above or below the first rail is space-saving and can reduce the amount of space (e.g., the footprint) required for the system.

The transport device can implement (be configured to enable) different transport speeds and/or (in) different transport directions. For example, the workpiece carriers can be moved at different points of the transport device at different speeds and/or in different directions. In this way, for example, cooling times and/or drying times can be provided without hindering other processes.

In another aspect of the present teachings, one or more buffer segments can be provided in or along in the transport device to make it possible that workpiece carriers having (holding) prepared cables can wait before a currently occupied processing station and can thereafter approach the processing station as soon as it becomes free. Workflows can be optimized thereby and utilization of processing capacities can be improved (made more efficient).

A module for a system for assembling electrical cables can be manufactured, in principle, without processing stations. Processing stations can be installed on the machine base as required depending on the processing steps to be performed. A variety of different processing stations can be used. Processing stations can be retrofitted, rearranged, replaced or removed. Existing processing stations need not necessarily be used. For example, certain processing stations can be used only for certain processing operations.

The system can be configured to assemble differing electrical cables by using differing contact parts/connectors (e.g., plugs, sockets, etc.). Processing stations that are required for processing a particular electrical cable need not be required for processing another electrical cable and accordingly need not be operated by the transport device when processing such other electrical cable. Various processing options are provided which can be switched in a flexible manner. For example, it is possible to switch between single-sided (single end) processing and double-sided (both end) processing of electrical cables. A sequential processing according to different designs is possible thereby. The system can be designed for a single part production and/or a batch production, or can be quickly switched between them, or a set of cables can be produced.

Protective measures can be implemented using a protective hood. The protective hood can be configured such that it can be opened, e.g., for maintenance purposes. By using a profile frame, the protective hood can be easily assembled, extended and flexibly designed.

In another aspect of the present teachings, modules can be configured to be connected to each other using predefined and compatible (complementary) connection points. The connection points can be provided, e.g., on the welded frame. One connection point or at least two or at least three or at least four connection points can be provided on each side of a module along the x-axis. The connection points can have, e.g., standardized mechanical connection points. Using the connection points, the modules can be connected to each other and positioned, preferably at the same time. The connection points can, in additional or in the alternative, have an electrical, pneumatic and/or hydraulic interface, which can be mapped, e.g., via a modular standard interface. The modules and/or the connection points can be connected to each other according to the plug-socket principle.

Preferably, each module has a first connection point on a first side along the transport direction, and a second connection point on a second side opposite to the first side. Preferably, the first connection point is configured to be compatible with (complementary to) the second connection point such that the respective module on the first side and/or the second side is connectable to at least one additional module that also has the first connection point and/or the second connection point. Preferably, the transport devices of the two modules are connected to each other and form a common transport device. Preferably, the first connection points of all or some of the modules are identical. Preferably, the second connection points of all or some of the modules are identical.

By connecting two or more modules, the size of the system can be easily adjusted as required. Also, an existing system can be subsequently expanded by adding one or more modules. Modules can be replaced or removed. By using the predefined connection points, the modules can be connected in a suitable sequence in an easy and time-saving manner. Effort to build/modify or extend the system is minimized. The transport device of a module can include removable connecting pieces/reversing (curved) rails/terminating elements at its two ends along the x-axis. The transport devices of modules to be connected to each other can be connectable to a combined transport device after removal of the connecting pieces/reversing rails/terminating elements from the ends to be connected. The ends of the combined transport device can be closed by connecting pieces/reversing rails/terminating elements. The combined transport device can make possible a continuous transport of electrical cables through the system.

Due to the modularity of the system, the system can be upgraded, e.g., from a minimum configuration having few processing stations and manual loading to a full configuration having numerous processing stations and automated loading. For example, a conductor-/cable winder and/or an automated conductor-/cable feeder can be used as the loader.

The transport device can be coupled to other transport systems and/or logistics systems.

In another aspect of the present teachings, the system can include a central controller that controls the operation of the individual (respective) modules. The controller can control the operation of the processing stations and/or the transport device. Each module can include a controller that controls the operation of the processing stations and/or the transport device in the module. The controllers of the individual modules can be controlled, e.g., by the central controller. The controller of one of the modules can serve as a host and control the controllers of the other modules.

The central controller of the system/host can be configured to automatically recognize modules incorporated in the system and to adjust (modify) operation at the incorporated modules based on the entire set of processing that will be performed. An expansion of the system is simplified thereby and the amount of work and time required for a changeover is minimized. The processing stations installed in one module/the modules can be automatically recognized and referenced. The modules can include predefined plug connections, e.g., for connection to the controller, and/or to a CAN (Controller Area Network) bus system and/or to another bus system.

The system can include a loading station. The loading station can include, e.g., manual hand loading and/or an automated conductor-/cable inserter/coiler. The loading station can be configured as a module or a module can include an loading station.

The system can include a supply station for feeding, e.g., contact parts (e.g., plugs, connectors, terminals, etc.), which are to be crimped to the electrical cables, to one or more processing stations. The supply station can be provided, e.g., on a module.

The system can include a deposit station in which the electrical cables after the processing are deposited, e.g., by the workpiece carriers, and from which the electrical cables after being deposited can be removed. The deposit station can be configured as a module or a module can include a deposit station.

The system can be produced according to a concept known as “lean”, so that the production time of the system can be minimized. Components such as welded frames, profile frames, processing stations, etc. can be produced independently and preferably with standard dimensions and combined as required. Interdependencies between components can be avoided.

### BRIEF DESCRIPTION OF THE DRAWINGS

Further features and utilities will be apparent from the description of exemplary embodiments based on the figures.

FIG. 1 shows a perspective view of a system for assembling electrical cables according to the present teachings.

FIG. 2 shows a perspective view of a module for the system.

FIG. 3A shows a side view of the module without processing stations and FIG. 3B shows a side view of the module with processing stations mounted on a support.

FIG. 4 shows a transport device according to the present teachings.

FIGS. 5A-5D respectively show different configurations of workpiece carriers that are holding electrical cables.

FIG. 6 shows a schematic top view of the system.

### DETAILED DESCRIPTION OF THE EMBODIMENTS OF THE INVENTION

An exemplary, non-limiting embodiment of the present teachings is described below with reference to the figures. Identical features are denoted with the same reference signs in all figures, wherein all reference signs are not used in all figures for reasons of clarity.

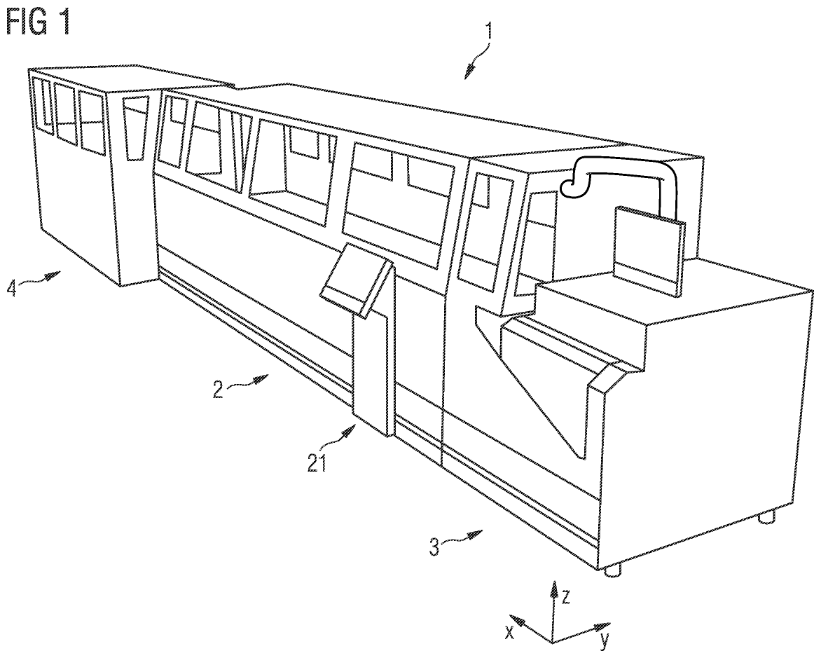

FIG. 1 shows a system 1 for assembling electrical cables. A coordinate system having a z-axis extending vertically in the drawing plane, an x-axis and a y-axis is provided in FIG. 1. The coordinate system is for explanatory purposes and does not restrict the orientation of the system. However, the z-axis is preferably oriented substantially vertically and parallel to the direction of gravity, and the x-axis and y-axis are oriented substantially horizontally.

The system 1 includes a module 2, a loading station 3 and a deposit station 4, which are connected to each other along the x-axis. The module 2 is located between the loading station 3 and the deposit station 4. The module 2 is exchangeable. Two or more modules 2 can be provided between the loading station 3 and the deposit station 4. The module 2 can preferably have a length along the x-axis in the range of 0.5 m to 10 m, preferably 1 m to 5 m, for example 1.5 m or 3 m. The module 2 can preferably have a height along the z-axis in the range of 1 m to 10 m, preferably 2 m to 4 m. The module 2 may preferably have a width along the y-axis in the range of 0.5 m to 10 m, preferably 1 m to 5 m.

The system 1 includes a controller 21 that controls the operation of the system 1.

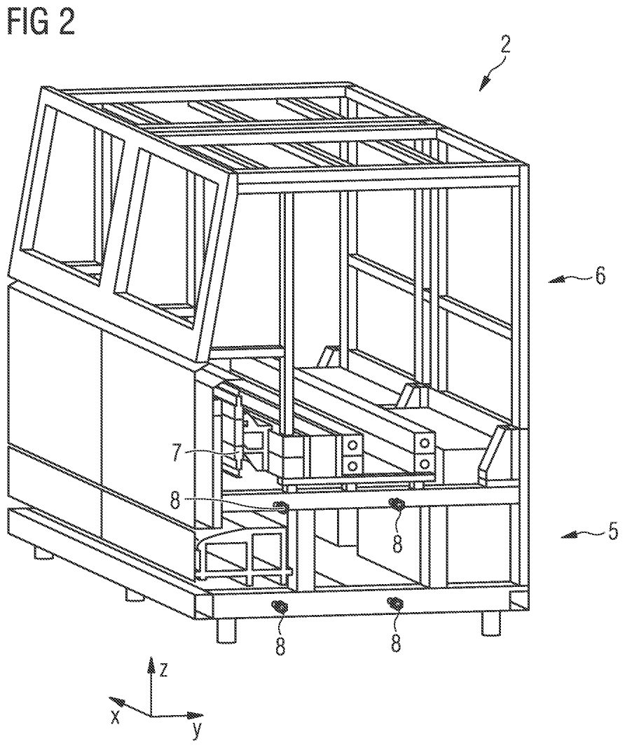

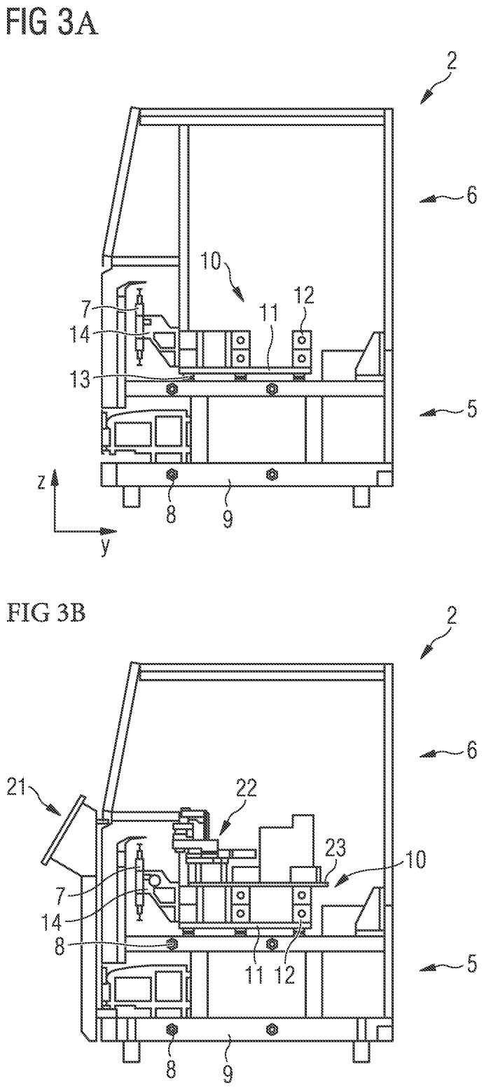

A module 2 is shown in FIG. 2. The module 2 includes a machine base 5, a protective hood 6, a transport device 7 and first connection points 8. Side views of the module 2 are shown in FIGS. 3A and 3B.

The machine base 5 includes a welded frame 9. The first connection points 8 are provided on the welded frame 9 on a first side of the module 2 along the x-axis. In the present embodiment, four first connection points 8 are provided on the first side of the module 2 along the x-axis. Although not shown in the drawings, four second connection points, which are compatible with (correspond to) the first connection points 8 on the first side, are also provided on the welded frame 9 on a side of the module 2 opposite the first side along the x-axis. The first connection points 8 of the module 2 can be connected to the second connection points of another module, which is affixed to the module 2 on the first side along the x-axis. The first connection points 8 of the module 2 can also be connected to second connection points provided on the loading station 3. The second connection points of the module 2 can be connected to first connection points provided on the deposit station 4. The system 1 shown in FIG. 1 can be formed in this manner.

The system 1 may include one module 2 or multiple modules 2 placed side-by-side along the x-axis. In the system 1, the first connection points 8 and the second connection points may be interchanged, i.e., the first connection points 8 may be located on the second side of the module(s) 2 and the second connection points may be located on the first side of the module(s) 2. The loading station 3 can be located on the first side of the system 1 or on the second side of the system 1, and the deposit station 4 can be located on the opposite side in each case.

The protective hood 6 is disposed above the machine base 5. The protective hood 6 covers the machine base 5, the support 10 and the transport device 7. The machine base 5 and the protective hood 6 form a space for accommodating one or more processing stations 22. The protective hood 6 also covers the processing stations 22. The protective hood 6 is constituted from profile frames (e.g., one or more of bars, beams, struts, brackets, panels, etc.). The protective hood 6 can be at least partially opened and closed. The protective hood 6 preferably has hinges and springs for opening and closing the protective hood 6.

The machine base 5 has a support 10. The support 10 has a plate 11 and profiles (e.g., bars, beams, struts, brackets, etc.) 12 for mounting one or more processing stations 22. The profiles 12 are formed separately and are rigidly attached to the plate 11 or are integrally formed with the plate 11. The support 10 is disposed on the welded frame 9. The support 10, or more specifically the plate 11, is connected to the welded frame 9 via compensating elements 13.

The horizontal orientation of the support 10 or the plate 11 can be adjusted by manipulating the compensating elements 13.

As shown in FIG. 3B, a processing station 22 can be mounted on the support 10. In the present embodiment, the processing station 22 has a base plate 23, which is mounted on the profiles 12. Other elements of the processing station 22 are located on the base plate 23. Various types of processing stations 22 can be used. For example, a processing station 22 is a device utilized in assembling electrical cables. More specifically, a processing station 22 may include one or more devices for stripping of cable ends and/or for expanding shields (e.g., braided shields) of cable ends and/or for crimping of contact parts, plugs, terminals or other types of connection means to cable ends and/or for orienting of electrical cables and/or for joining of parts onto electrical cables to be processed and/or for inspection (e.g., monitoring, e.g., visual or optical inspection) and/or for quality inspection (e.g., quality control), as will be further described below. For example, at least one or at least two or at least three processing stations 22 can be or are preferably mountable on the support 10 side by side in one direction along the x-axis. Processing positions of processing stations 22, which are arranged side by side, are preferably substantially at the same height in a direction along the z-axis.

A holder (e.g., a bracket, flange, etc.) 14 for mounting (holding, retaining) the transport device 7 is attached to the support 10. The holder 14 is attached directly to the support 10. The transport device 7 is connected directly to the support 10 by the holder 14 and not to the welded frame 9. The transport device 7 is configured to pick up electrical cables/cable ends to be processed at the loading station 3, to move/transport them to and away from the processing station(s) 22 and to deposit them at the deposit station 4. The transport device 7 is arranged such that electrical cables transported by the transport device 7 can be processed by processing stations 22 mounted on the support 10. The transport device 7 is located on the machine base 5 primarily above the welded frame 9. Alternatively, the transport device 7 can project from the machine base 5 or the welded frame 9 along the y-axis. The holder 14 is attached to one end of the support 10 along the y-axis. The transport device 7 is located adjacent to the support 10 on one side along the y-axis. The transport device 7 extends along the x-axis and the z-axis. The longitudinal direction of the transport device 7 extends along the x-axis.

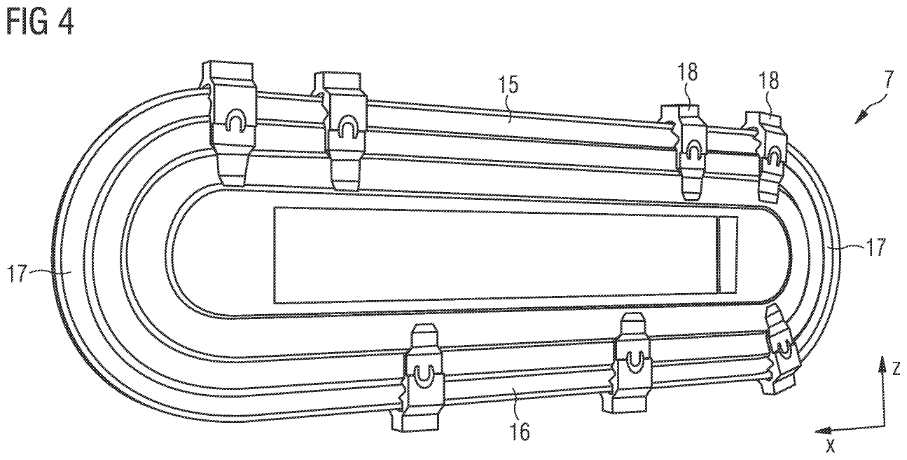

The transport device 7 is shown in FIG. 4. The transport device 7 has a first rail 15 and a second rail 16. The transport device 7 shown in FIG. 4 also has two connecting pieces 17. The first rail 15 and the second rail 16 each extend horizontally along the x-axis. The first rail 15 and the second rail 16 are each formed in a linear (e.g., straight) manner. The first rail 15 is located above the second rail 16. The transport device 7 is attached to the support 10 via the holder 14 such that the first rail 15 is located at least substantially at the same height as the processing positions of the processing stations 22, or slightly below the processing positions, with reference to a direction along the z-axis.

The first rail 15 and the second rail 16 are connected to each other at their respective ends via the connecting pieces 17. The connecting pieces 17 are removable. After removal of the respective connecting pieces 17, the first rails 15 or the second rails 16 of the to-be-connected modules 2/loading station 3/deposit station 4 can be connected to form a combined transport device. The rails 15, 16 can have compatible plug-socket connectors at their ends. In particular, the connecting pieces 17 can be attached to the ends of the combined transport device, for example in the loading station 3 and the deposit station 4. The ends of the combined transport device are not required to be located in the loading station 3 and the deposit station 4, but can also be located, e.g., in a module 2.

The transport device 7 includes multiple (seven in the embodiment shown in FIG. 4) workpiece carriers 18. The workpiece carriers 18 are configured to respectively hold and transport electrical cables/cable ends. The workpiece carriers 18 are movable along the first rail 15, the second rail 16 and the connecting pieces 17. The workpiece carriers 18 can be moved along the first rail 15, one of the two connecting pieces 17, the second rail 16, and the other of the two connecting pieces 17 in a revolving (e.g., circulating) manner. The workpiece carriers 18 can be movable in a revolving manner in one direction or in both directions. The workpiece carriers 18 are driven magnetically, preferably by a linear motor. The transport device can be, for example, the linear transport system XTS® of Beckhoff Automation GmbH; see also US 2021/159834 A1 and US 2013/313072 A1, the contents of both of which are incorporated herein by reference.

The workpiece carriers 18 pick up the electrical cables/cable ends at the loading station 3, hold them during transport from processing station 22 to processing station 22 and deposit them at the deposit station 4. The workpiece carriers 18 are provided, for example, with grippers (e.g., clamps) for holding the electrical cables/cable ends. The grippers can be actuated mechanically/electrically/magnetically/pneumatically/hydraulically. The grippers can be controlled, e.g., by the controller 21.

The transport device 7 of an individual module 2 need not include the two connecting pieces 17. For adjacently-placed and interconnected modules 2 as well as the loading station 3 and the deposit station 4 at the two ends of the system 1, the respective first rails 15 are interconnected to form a combined first rail and the respective second rails 16 are interconnected to form a combined second rail. The connecting pieces 17 are located at the two ends of the combined transport device obtained in this way, or of the combined first rail and the combined second rail, so that the workpiece carriers 18 can be moved in a revolving manner around the combined first rail, the one connecting piece 17, the combined second rail and the other connecting piece 17. The workpiece carriers 18 can thus be moved from the loading station 3 along the module 2 or modules 2 to the deposit station 4 and back.

The workpiece carriers 18 can be moved independently of each other. The workpiece carriers 18 can be moved at different speeds and/or in different directions and can stop at any location along the first rail 15, the second rail 16, and the connecting pieces 17. One or more workpiece carriers 18 can be moved while another one or more workpiece carriers 18 is/are not moved. The movement speeds and movement directions of individual workpiece carriers 18 can be the same or different from each other. Thus, the workpiece carriers 18 can be moved asynchronously and without pitch, i.e., with different movement distances between successive stopping points.

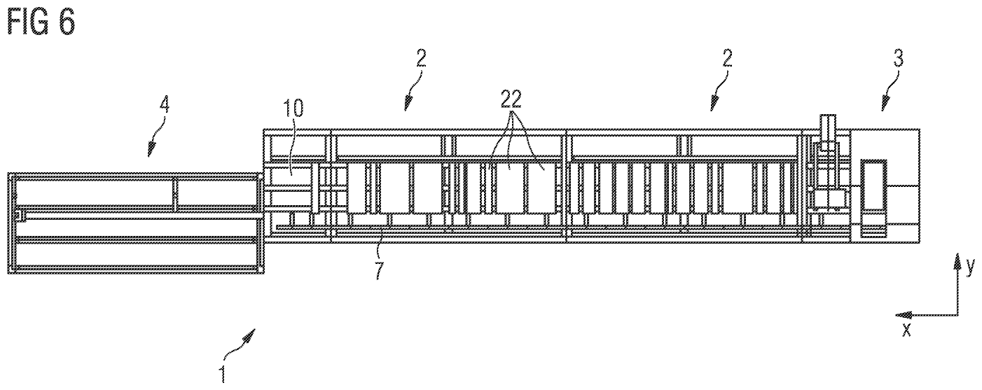

The processing stations 22 can be mounted on the support 10 at different distances or at equal distances. The spacings of the processing positions of the processing stations 22 along the x-axis can be the same or at least partially different. The space available on the support 10 can thus be used optimally. FIG. 6 shows a top view of the system 1 with processing stations 22 mounted on the support 10 side by side along the x-axis. The processing positions of the processing stations 22 along the z-axis are preferably the same, i.e. are at the same height.

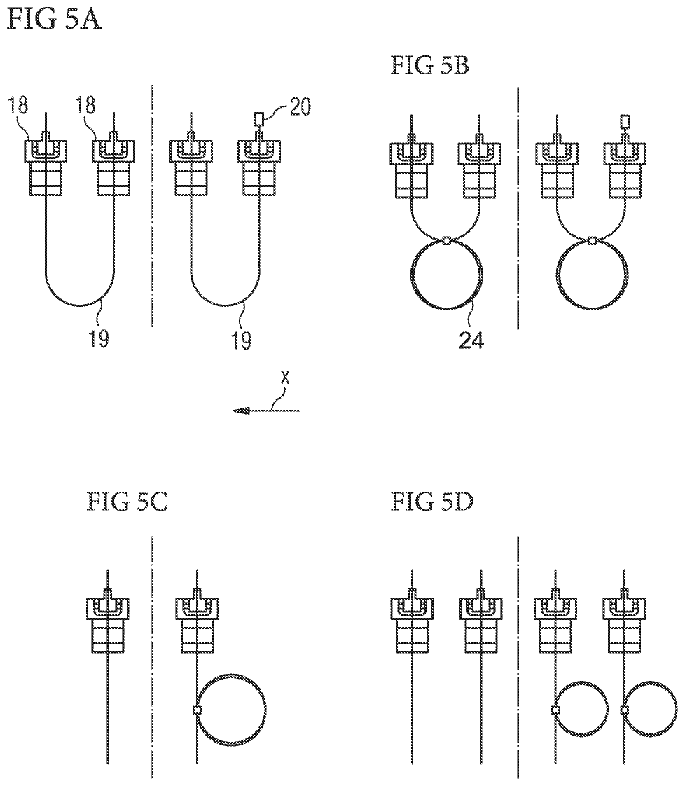

Workpiece carriers 18 having differently designed cables 19 (e.g., electrical cables) are shown in FIG. 5. For example, the two ends of a single cable 19 can be supported or held by two adjacent workpiece carriers 18 in the transport device 7 and the cable 19 can be present as (held in the form of) a loop between them, as shown in FIG. 5A and FIG. 5B. In this embodiment, both ends of the cable 19 can be processed. In the alternative, only one end of a cable 19 can be processed and thus supported or held by one workpiece carrier 18, as shown, for example, in FIG. 5C and FIG. 5D. Both ends of one cable 19 can each be carried by one workpiece carrier 18 and both can be processed simultaneously, or one of the two ends of the cable 19 can be processed in each case. Both ends of a cable 19 can be carried by a single workpiece carrier 18. Depending on the length of the cable 19, a portion of the cable 19 may be in the form of a coil or loop 24, as shown for example in FIG. 5B and on the right side in FIG. 5C and FIG. 5D. A contact part (e.g., a plug, a connector, a terminal, etc.) 20 can be attached to only one end of one cable 19 or contact parts 20 can be respectively attached to both ends of one cable 19.

The workpiece carriers 18 can pick up the cables 19 to be processed, or the ends thereof, at the loading station 3, move them along the first rail 15 through the processing segment formed by the module(s) 2 from processing station 22 to processing station 22, and deposit the processed (e.g., completed) cables 19 at the deposit station 4.

A large number of different processing situations (modes) can be realized.

For example, a processing station 22 can have one processing position that is configured to be approached by (receive) the workpiece carriers 18 in succession. In the alternative, one processing station 22 can have two processing positions that are configured to be approached simultaneously by (simultaneously receive) two workpiece carriers 18 or that are approached successively by one workpiece carrier 18 or of which only one is approached by one workpiece carrier 18 in each case. There can be two processing stations 22, each with one processing position, which are approached simultaneously by two workpiece carriers 18, wherein the two processing stations 22 can be identical.

Processing stations 22 can be switched off, for example, if they are not required for a particular processing operation. A switched-off processing station 22 can nevertheless be approached by the workpiece carriers 18 if this is necessary, for example, due to the length of the cable 19 to be processed, or may not be approached.

The transport device 7 can have one or more buffer segments on (along) which one or more workpiece carriers 18 can wait, e.g., while a downstream processing station 22 is occupied by another workpiece carrier 18. Preferably, the buffer segment(s) can be located upstream of one or more cycle-time-critical module(s). In the buffer segment, a waiting workpiece carrier 18 can stop, i.e. not be moved, or can be moved at a reduced speed.

In the embodiment described above, the workpiece carriers 18 are driven magnetically. Alternatively, other drive systems can be used. For example, the workpiece carriers can be driven mechanically.

In the embodiment described above, the workpiece carriers 18 are moved along the first rail 15, the one connecting piece 17, the second rail 16 and the other connecting piece 17 in a revolving (circulating) manner around an endless loop formed by these parts. Alternatively, a transport device having only one rail can be used. The workpiece carriers 18 can be moved along the one rail from processing station 22 to processing station 22 to process the cables 19, and, after completion of the processing, can be moved back along the same rail in the opposite direction.

The support 10 can be omitted. The processing stations 22 and/or the transport device 7 can be mounted (e.g., directly or indirectly) on the welded frame 9 or on another part attached to the machine base 5.

The protective hood 6 can be omitted. The protective hood 6 need not be constituted from profile frames.

The system 1 need not include the controller 21. The system 1 can be controlled externally.

The system 1 can include a single module 2 or multiple modules 2. The loading station 3 and/or the deposit station 4 may be omitted or replaced by an alternative station or system for feeding or discharging electrical cables. The loading station 3 and the deposit station 4 can be combined and the cables 19 can be transported back, e.g., after the processing from the workpiece carriers 18 along the second rail 16 to the combined loading and deposit station. The loading station and/or the deposit station can be integrated into one module.

It is explicitly stated that all features disclosed in the description and/or claims are intended to be disclosed separately and independently of each other for both the purpose of the original disclosure and the purpose of limiting the claimed invention, regardless of the combination of features in the embodiments and/or in the claims. It is explicitly stated that all ranges of values or indications of groups of objects disclose all possible intermediate values or all possible intermediate objects both for the purpose of original disclosure and for the purpose of limiting the claimed invention, in particular for determining the boundaries of ranges of values.

Additional embodiments of the present teachings include, but are not limited to:

1. Module (2) for a system (1) for assembling electrical cables (19), including:
a machine base (5) on which at least one processing station (22) for processing electrical wires (19) is mountable, and
an asynchronous and pitch-free transport device (7) for transporting at least one of the electrical cables (19) to the at least one processing station (22) and/or away from the at least one processing station (22).

2. Module (2) according to the above Embodiment 1, wherein:
the machine base (5) has a welded frame (9) to which a support (10) is attached, the at least one processing station (22) is mountable to the support (10), and the transport device (7) is attached to the support (10).

3. Module (2) according to the above Embodiment 1 or 2, wherein the transport device (7) has a plurality of independently driven workpiece carriers (18) for transporting at least one of the electrical cables (19) and is configured to move the workpiece carriers (18) asynchronously and without pitch.

4. Module (2) according to the above Embodiment 3, wherein the transport device (7) is configured to drive the workpiece carriers (18) magnetically.

5. Module (2) according to the above Embodiment 3 or 4, wherein the transport device (7) is configured to move the workpiece carriers (18) linearly in a first direction.

6. Module (2) according to any one of the above Embodiments 3 to 5, wherein the transport device (7) includes a first rail (15) and a second rail (16) and is configured to move the workpiece carriers (18) along the first rail (15) in the first direction and along the second rail (16) in a second direction opposite to the first direction, wherein the at least one electrical cable (19) preferably is transported only during the movement along the first rail (15).

7. Module (2) according to the above Embodiment 6, wherein:
the first and second rails (15, 16) extend horizontally and parallel to each other, and
the first rail (15) is disposed above or below the second rail (16).

8. Module (2) according to any one of the above Embodiments 3 to 7, wherein:
at least one processing station (22) for processing ends or intermediate portions of the electrical cables (19) is mounted on the machine base (5), and
the transport device (7) includes a buffer segment on which at least one workpiece carrier (18) having a cable (19) to be processed by the at least one processing station (22) can be located in a waiting state, wherein the workpiece carrier (18) is not moved or is moved at a reduced speed while the processing station (22) is occupied by another workpiece carrier (18).

9. Module (2) according to any one of the preceding Embodiments, wherein at least one processing station (22) for processing ends or intermediate portions of the electrical cables (19) is mounted on the machine base (5), wherein the at least one processing station (22) preferably is a device for assembling the electrical cables (19), in particular for stripping cable ends and/or for expanding shields of cable ends and/or for crimping of contact parts (20) or plugs or connecting means onto cable ends and/or for orienting electrical cables (19) and/or for joining parts (20) to electrical cables (19) to be processed and/or for inspection and/or for quality inspection.

10. Module (2) according to any one of the preceding Embodiments, further comprising:
a protective hood (6), preferably constituted from profile frames, which is capable of at least partially covering the machine base (5), the at least one processing station and the transport device (7).

11. Module (2) according to any one of the preceding Embodiments, further comprising:
a first connection point (8) on a first side along the transport direction, and
a second connection point on a second side opposite to the first side,
wherein the first connection point (8) is configured to be compatible with the second connection point such that the module (2) is connectable on the first side and/or on the second side to at least one additional module (2) according to one of the preceding Embodiments, which also has the first connection point (8) and/or the second connection point, such that the transport devices (7) of the two modules (2) are connected to one another and form a common transport device.

12. System (1) having at least one module (2) according to any one of the preceding Embodiments and a controller configured to control the operation of the at least one processing station and the transport device (7).

13. System (1) according to the above Embodiment 12 having at least two modules (2) according to the above Embodiment 11, wherein the at least two modules (2) are interconnected by connecting the second connection point of the first module (2) and the first connection point (8) of the second module (2).

14. System (1) according to the above Embodiment 12 or 13, wherein the controller is configured to automatically recognize the modules (2) incorporated in the system and to adjust the operation of the at least one processing station (22) and the transport device (7) in accordance with the incorporated modules (2).

15. System (1) according to any one of the above Embodiments 12 to 14, further including:
a loading station (3), which includes a cable winder and/or an automated cable feeder, and/or
at least one supply station, and/or
a deposit station (4).

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved modules and systems for assembling electrical cables, as well as methods of manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the controller 21, is also understood as a corresponding method step or as a feature of a method step. In an analogous manner, aspects which have been described in the context of or as a method step also represent a description of a corresponding block or detail or feature of a corresponding device, such as the controller 21.

Depending on certain implementation requirements, exemplary embodiments of the controller 21 of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor. For example, one or more of the same (e.g., two or more microprocessors) may be utilized in the design of the controller 21.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the controller 21 or controlling means, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components, and thus for example also perform complex processes using the electric motor 8 and other mechanical structures of the power tool.

Therefore, although some aspects of the controller 21 have been identified as “parts” or “units” or “steps”, it is understood that such parts or units or steps need not be physically separate or distinct electrical components, but rather may be different blocks of program code that are executed by the same hardware component, e.g., one or more microprocessors.

Generally speaking, one or more of the processing stations 22 according to the present teachings may be configured, e.g., according to one or more of the corresponding processing stations disclosed in U.S. Pat. No. 9,954,346 B2, the contents of which are incorporated fully herein by reference. For example, referring to the reference numerals shown in FIG. 1 of U.S. Pat. No. 9,954,346 B2 in parenthesis, one or more of the processing stations 22 according to the present teachings may be configured, e.g., as a station (3) for cutting cables to length, a station (5) for stripping cables, a station (6) for fitting a support sleeve, a station (7) for opening up a screening braid, a station (8) for cutting the screening braid, a station (9) for removing a foil, a station (10) for circumferential alignment (orientation), a station (12) for cutting away a filler and/or a station (15) for performing quality control (quality inspection). One or more of such processing stations may be disposed on a single support 10 of the present teachings.

More specifically, a processing station configured to strip (or peel) cable ends preferably comprises one or more devices configured to cut one or more layers of the cable (preferably at least an outer insulating/protective sheath), such as one or more blades or knives, one or more heating elements, one or more laser beams, etc., capable of cutting, slicing, or making an incision in the sheath of the cable, as well as optionally a device configured to remove (e.g., sever, ablate, etc.) a cut portion or cut portions of the sheath from the cable. Exemplary, non-limiting embodiments of devices capable of performing the cable end stripping function according to the present teachings are disclosed in the following representative disclosures, namely U.S. Pat. No. 5,596,802 A (e.g., cutting knives (12, 13) disclosed therein), U.S. Ser. No. 10/833,492 B2 (e.g., knife head (3) disclosed therein), US 2020/412114 A1 (e.g., peeling cutter (1) and cutting cutters (2) disclosed therein), and U.S. Pat. No. 9,876,338 B2 (e.g., one or more of the laser devices (diodes) (1; 101; 201) disclosed therein), the contents of all of which are incorporated fully herein by reference.

A processing station configured to expand, widen or flair a shield (e.g., a braided shield) of a cable end preferably includes, e.g., a cable clamping device having two or more, e.g., three, clamping bodies that are movable relative to each other and relative to the cable. An exemplary, non-limiting embodiment of a device capable of expanding, widening or flaring a shield of a cable end according to the present teachings is disclosed, e.g., in U.S. Ser. No. 10/347,400 B2 (e.g., clamping bodies (124) disclosed therein), the contents of which are incorporated fully herein by reference.

A processing station configured to crimp a contact part, a plug, a terminal or another type of connecting means onto a cable end (or onto one or more electric wires, conductors, cores, etc. disposed within the cable) may include an apparatus configured to locally deform the contact part, etc., to create a physical and/or electrical connection with the cable end (or more particularly, with one or more electric wires/conductors/cores disposed within the cable), such as is included, e.g., in the crimping device disclosed in U.S. Ser. No. 11/283,230 B2, which has a crimp anvil (16) that supports the contact part, etc., during the crimping process, and a crimper (die) (18) that re-shapes (bends) a portion of the contact part, etc., supported on the crimp anvil to bend it around a metal wire or wires (conductor(s), core(s)) contained in the electrical cable, or in US 2011/061235 (e.g., first die or anvil (47) and second die or crimper (48) disclosed therein), the contents of both of which are incorporated fully herein by reference.

A processing station configured to orient electrical cables preferably includes, e.g., a cable clamping device having two or more clamps or grippers that are movable relative to each other and relative to the cable to temporarily clamp (fixedly hold) the cable and optionally a device configured to rotate and/or otherwise move the clamped cable to a desired position and/or orientation. An exemplary, non-limiting embodiment of a device capable of orienting electrical cables according to the present teachings is disclosed, e.g., in U.S. Pat. No. 5,115,904 A (e.g., clamps (16) and optionally lead rotating apparatus (10) disclosed therein), the contents of which are incorporated fully herein by reference.

A processing station configured to join parts to electrical cables to be processed preferably includes a device capable of supplying and supporting parts for connection to the electrical cable and devices capable of joining such parts to the electrical cable. Exemplary, non-limiting embodiments of devices capable of joining parts to electrical cables to be processed according to the present teachings are disclosed in the following representative disclosures, namely U.S. Pat. No. 9,548,579 B2, U.S. Pat. No. 9,667,000 B1, and U.S. Ser. No. 10/468,786 B2, the contents of all of which are incorporated fully herein by reference.

A processing station configured to inspect electrical cables preferably includes, e.g., a device capable of visually or optically verifying the appearance of the processed electrical cables. Exemplary, non-limiting embodiments of devices capable of inspecting electrical cables according to the present teachings are disclosed in the following representative disclosures, namely US 2021/088326 A1 (e.g., one or more of cameras (C1, C2, C3) disclosed therein), U.S. Ser. No. 11/231,559 B2 (e.g., mirror apparatus (5), lighting device (3) and camera (2) disclosed therein), and U.S. Pat. No. 9,612,210 B2 (e.g., mirror assembly (602) or optics system (1606), lighting source (612) or lighting system (1604), and camera (610) or camera system (1602), and optionally including one or more digital microscopes (1302), disclosed therein), the contents of all of which are incorporated fully herein by reference.

A processing station configured to perform quality inspection preferably includes, e.g., one or more devices capable of measuring or detecting characteristic values of the processed electrical cables. An exemplary, non-limiting embodiment of a device capable of performing quality inspection according to the present teachings is disclosed, e.g., in US 2021/399512 A1 (e.g., any one or more of the sensor devices (14) disclosed therein, such as a sensing probe, an inductive sensor, a capacitive sensor and/or an optical sensor), the contents of which are incorporated fully herein by reference.

As can be understood from the preceding description, a cable to be assembled according to the present teachings may include one or more electric wires/conductors/cores, e.g., made of copper or other electrically-conductive material, that are optionally surrounded a metallic shield (e.g., a braided or mesh shield) for blocking electromagnetic fields in the form of a Faraday cage, which is in turn surrounded by an outer sheath that is preferably made of an elastic and electrically-insulating material, i.e. preferably a plastic material such as polyethylene. If the electric cable contains two or more electric wires/conductors/cores, they may extend in parallel or may be provided in the form of twisted pairs.

1. A module for a system for assembling electrical cables, including:
a machine base on which at least one processing station configured to process electrical cables is mountable, and
an asynchronous and pitch-free transport device configured to transport at least one of the electrical cables to the at least one processing station and/or away from the at least one processing station.

2. The module according to claim 1, wherein:
the machine base has a welded frame to which a support is attached,
the at least one processing station is mountable to the support, and
the transport device is attached to the support.

3. The module according to claim 1, wherein the transport device has a plurality of independently driven workpiece carriers configured to transport the at least one of the electrical cables and is configured to move the workpiece carriers asynchronously and without pitch.

4. The module according to claim 3, wherein the transport device is configured to drive the workpiece carriers magnetically.

5. The module according to claim 3, wherein the transport device is configured to move the workpiece carriers linearly in a first direction.

6. The module according to claim 3, wherein:
the transport device includes a first rail and a second rail and is configured to move the workpiece carriers along the first rail in a first direction and along the second rail in a second direction opposite to the first direction, and
the transport device is configured to transport the at least one of the electrical cables only during movement along the first rail.

7. The module according to claim 6, wherein:
the first and second rails extend horizontally and parallel to each other, and
the first rail is disposed above or below the second rail.

8. The module according to claim 3, wherein:
the at least one processing station is mounted on the machine base and is configured to process ends or intermediate portions of the electrical cables, and
the transport device includes a buffer segment configured to enable at least one of the workpiece carriers having the at least one of the electrical cables to be processed by the at least one processing station to wait, either not moving or moving at a reduced speed, while the at least one processing station is occupied by another one of the workpiece carriers.

9. The module according to claim 1, wherein:
the at least one processing station is mounted on the machine base and is configured to process ends or intermediate portions of the electrical cables, and
the at least one processing station is configured to perform at least one processing operation selected from the group consisting of:
stripping cable ends,
expanding shields of cable ends,
crimping of contact parts or plugs or connecting means onto cable ends,
orienting electrical cables,
joining parts to electrical cables to be processed,
inspection, and
quality inspection.

10. The module according to claim 1, further comprising:
a protective hood that at least partially covers the machine base, the at least one processing station and the transport device.

11. The module according to claim 1, further comprising:
a first connection point on a first side along the transport direction, and
a second connection point on a second side opposite to the first side,
wherein the first connection point is configured to be compatible with the second connection point such that the module is connectable on the first side and/or on the second side to at least one additional module, which also has the first connection point and/or the second connection point, such that the transport devices of the two modules are connected to one another and form a common transport device.

12. A system comprising:
the module according to claim 1, and
a controller configured to control operation of the at least one processing station and the transport device.

13. A system comprising at least two modules according to claim 11, wherein the at least two modules are interconnected by connecting the second connection point of the first module with the first connection point of the second module.

14. The system according to claim 13, wherein the controller is configured to automatically recognize the at least two modules incorporated in the system and to adjust the operation of the at least one processing station and the transport device in accordance with the incorporated modules.

15. The system according to claim 13, further including:
a loading station, which includes a cable winder and/or an automated cable feeder, and/or
at least one supply station, and/or
a deposit station.

16. The module according to claim 3, wherein the transport device has a plurality of independently driven workpiece carriers configured to transport at least one of the electrical cables and is configured to move the workpiece carriers asynchronously and without pitch.

17. The module according to claim 16, wherein the transport device is configured to drive the workpiece carriers magnetically and to move the workpiece carriers linearly in a first direction.

18. The module according to claim 17, wherein:
the transport device includes a first rail and a second rail and is configured to move the workpiece carriers along the first rail in the first direction and along the second rail in a second direction opposite to the first direction, and
the transport device is configured to transport the at least one of the electrical cables only during movement along the first rail.

19. The module according to claim 18, wherein:
the first and second rails extend horizontally and parallel to each other,
the first rail is disposed above or below the second rail,
the at least one processing station is mounted on the machine base and is configured to process ends or intermediate portions of the electrical cables, and
the transport device includes a buffer segment configured to enable at least one of the workpiece carriers having the at least one of the electrical cables to be processed by the at least one processing station to wait, either not moving or moving at a reduced speed, while the at least one processing station is occupied by another one of the workpiece carriers.

20. The module according to claim 19, wherein the at least one processing station is configured to perform at least one processing operation selected from the group consisting of:
stripping cable ends,
expanding shields of cable ends,
crimping of contact parts or plugs or connecting means onto cable ends,
orienting electrical cables,
joining parts to electrical cables to be processed,
inspection, and
quality inspection.
